(19) United States
(12) Patent Application Publication
(10) Pub. No.: US 2021/0048580 A1
(43) Pub. Date: Feb. 18, 2021

(54) METHOD FOR MANUFACTURING OPTICAL DEVICE, OPTICAL DEVICE, AND MANUFACTURING DEVICE FOR OPTICAL DEVICE

(71) Applicant: SUMITOMO ELECTRIC INDUSTRIES, LTD., Osaka (JP)

(72) Inventor: Shigehiro Nagano, Osaka-shi (JP)

(73) Assignee: SUMITOMO ELECTRIC INDUSTRIES, LTD., Osaka (JP)

(21) Appl. No.: 17/088,069

(22) Filed: Nov. 3, 2020

Related U.S. Application Data
(63) Continuation of application No. PCT/JP2019/020745, filed on May 24, 2019.

(30) Foreign Application Priority Data
May 31, 2018 (JP) 2018-105071

(51) Int. Cl. G02B 6/12; G02B 6/13; B23K 26/06; B23K 26/0622; B23K 26/073

(52) U.S. Cl. CPC G02B 6/12002; G02B 6/13; B23K 26/0665; B23K 26/0622; B23K 26/064; B23K 26/0734; B23K 26/0613; G02B 2006/12038; B23K 26/073

(57) ABSTRACT

A method for manufacturing an optical device includes: a laser irradiation step of condensing pulsed first laser light and pulsed second laser light to the inside of a glass member including germanium and titanium; and a condensing position movement step of moving condensing positions relatively to the glass member. Each of the first laser light and the second laser light has a repetition frequency of 10 kHz or greater. The first laser light is condensed to a dot-shaped condensing region, and the second laser light is condensed to an annular condensing region surrounding the condensing region of the first laser light. A central wavelength of the first laser light is greater than 400 nm and equal to or less than 700 nm, and a central wavelength of the second laser light is equal to or greater than 800 nm and equal to or less than 1100 nm.

### CROSS-REFERENCE TO RELATED APPLICATIONS

This application is a continuation application of PCT/JP2019/020745 claiming the benefit of priority of the Japanese Patent Application No. 2018-105071 filed on May 31, 2018, the entire contents of which are incorporated herein by reference.

### BACKGROUND ART

The present invention relates to a method for manufacturing an optical device, an optical device, and a manufacturing apparatus for an optical device. In a technical field such as optical network communication, the scale of a data center and the capacity of communication data are rapidly increasing in accordance with expansion of a cloud service. As an example thereof, application of an optical IC using silicon photonics, or multi-core optical fiber (hereinafter, referred to as “MCF”) as a high-density optical interconnection has been examined. The MCF has attracted attention as a next-generation large-capacity optical fiber because the MCF can be means for avoiding an allowable limit due to a fiber fuse phenomenon that occurs when high-power light is incident to the optical fiber by space division multiplexing method. However, a technology of connecting MCFs adjacent to each other, or a technology for branching and connecting from each of a plurality of cores of the MCF to a plurality of single-core fibers is necessary for employing optical components such as the MCF. As a component capable of establishing connection between optical components, for example, a low profile coupler, a grating coupler, or the like can be used. Manufacturing of a three-dimensional optical waveguide device in which an optical waveguide is formed at the inside of glass by laser drawing has attracted attention from the viewpoint of productivity and the degree of freedom of design.

With regard to the three-dimensional optical waveguide device obtained by laser drawing which has been reported so far, a glass material, an additive material, an additive amount, or irradiation conditions of femtosecond laser (for example, a wavelength of 800 nm or less) by a titanium sapphire laser have been examined. For example, according to Non Patent Literature 1, phosphate-based glass containing TiO₂ is irradiated with laser light, thereby succeeding to form a refractive index difference (that is, a refractive index variation) Δn to approximately 0.015 at the inside of glass. According to Patent Literature 1, quartz glass having a composition of GeO₂: 5% by weight is irradiated with laser light, thereby succeeding to raise the refractive index inside the glass by 0.02.

### CITATION LIST

### Patent Literature

Patent Literature 1: Japanese Unexamined Patent Publication No. H9-311237

### Non Patent Literature

Non Patent Literature 1: Masakiyo Tonoike “The Result of the finished national project on “High-efficiency Processing Technology for 3-D Optical Devices in Glass””, NEW GLASS Vol. 26, No. 3, 2011, pp. 33 to 44.
Non Patent Literature 2: D. L. Williams, et al., “ENHANCED UV PHOTOSENSITIVITY IN BORON CODOPED GERMANOSILICATE FIBERS”, ELECTRONICS LETTERS, 7 Jan. 1993, Vol. 29, No. 1, pp. 45 to 47.
Non Patent Literature 3: B. I. Greene, et al., “Photoselective Reaction of H₂ with Germanosilicate Glass”, LEOS' 94 (1994), Vol. 2, PD-1.2, pp. 125 to 126.
Non Patent Literature 4: Junji Nishii, et al., “Ultraviolet-radiation-induced chemical reactions through one- and two-photon absorption process in GeO₂—SiO₂ glasses”, OPTICS LETTERS, Vol. 20, No. 10, May 15, 1995, pp. 1184 to 1186.

### SUMMARY OF INVENTION

The present disclosure provides a method for manufacturing an optical device. The method for manufacturing an optical device includes: a laser irradiation step of condensing pulsed first laser light and pulsed second laser light the inside of a glass member including germanium and titanium to cause a photo-induced refractive index variation in the glass member; and a condensing position movement step of moving condensing positions of the first laser light and the second laser light relatively to the glass member. Each of the first laser light and the second laser light has a repetition frequency (that is, the number of pulses per second) of 10 kHz or greater. The laser irradiation step includes condensing the first laser light to a dot-shaped condensing region and condensing the second laser light to an annular condensing region surrounding the condensing region of the first laser light. The first laser light has a central wavelength equal to or greater than 400 nm and equal to or less than 700 nm, and the second laser light has a central wavelength equal to or greater than 800 nm and equal to or less than 1100 nm. The laser irradiation step and the condensing position movement step are alternately repeated, or are performed in parallel to form a continuous refractive index variation region in the glass member.

The present disclosure provides an optical device. The optical device includes a glass member that includes germanium and titanium. The glass member includes a photo-induced continuous refractive index variation region at the inside. The refractive index variation region includes a first region that extends in a linear shape, and a second region in a tubular shape surrounding the first region. A refractive index of the first region is greater than a refractive index of a region at the periphery of the refractive index variation region. A refractive index of the second region is smaller than the refractive index of the region at the periphery of the refractive index variation region.

The present disclosure provides a manufacturing apparatus for an optical device. The manufacturing apparatus for an optical device forms a continuous refractive index variation region the inside of a glass member. The manufacturing apparatus includes a first laser light source; a second laser light source, a conversion element, a wavelength combiner, and a condensing optical system. The first laser light source emits first laser light in which a central wavelength is greater than 400 nm and equal to or less than 700 nm, and which has a repetition frequency of 10 kHz or greater. The second laser light source emits second laser light in which a central wavelength is equal to or greater than 800 nm and equal to or less than 1100 nm, and which has a repetition frequency of 10 kHz or greater. The conversion element is disposed on an optical path of the second laser light emitted from the second laser light source, and converts a beam profile of the second laser light into an annular shape. The wavelength combiner is disposed on the optical path of the first laser light and the second laser light, and combines the first laser light, and the second laser light of which the beam profile is converted by the conversion element. The condensing optical system condenses laser light combined by the wavelength combiner to a predetermined processing position of the glass member.

### BRIEF DESCRIPTION OF DRAWINGS

FIG. 1 is a cross-sectional view illustrating a structure of an optical device 1, and illustrates a cross-section along an extension direction of an optical waveguide 2 provided in the optical device 1.

FIG. 2 is a cross-sectional view illustrating a structure of the optical device 1, and illustrates a cross-section orthogonal to the extension direction of the optical waveguide 2 (that is, a cross-section II-II in FIG. 1) in an enlarged manner.

FIG. 3 is a graph showing a refractive index distribution in a diameter direction of the optical waveguide 2.

FIG. 4 is a view schematically illustrating a configuration of a manufacturing apparatus for manufacturing the optical device 1.

FIG. 5A is a view illustrating a cross-sectional shape of second laser light P2 that is input to a laser shape conversion element 14.

FIG. 5B is a view illustrating a cross-sectional shape of the second laser light P2 that is output from the laser shape conversion element 14.

FIG. 6A is a graph showing an example of a beam profile of the second laser light P2 that is input to the laser shape conversion element 14.

FIG. 6B is a graph showing an example of a beam profile of the second laser light P2 that is output from the laser shape conversion element 14.

FIG. 7 is a flowchart illustrating a method for manufacturing the optical device 1.

FIG. 8 is a view illustrating a condensing region C1 of first laser light P1 and a condensing region C2 of the second laser light P2 in a cross-section of a glass member 3 that is orthogonal to an optical axis of a condensing optical system 16.

FIG. 9 is a graph showing results of measurement on a transmittance variation for an incident light wavelength with respect to each material (for example, SiO₂, GeO₂, or B₂O₃) that constitutes the glass member.

### DESCRIPTION OF EMBODIMENTS

### Problem to be Solved by Present Disclosure

The present inventors have made an investigation on a method for manufacturing an optical waveguide device of the related art, and as a result, they found the following problems. That is, according to the methods disclosed in Patent Literature 1 or Non Patent Literature 1, the maximum refractive index variation, that is, |Δn| is approximately 0.020, and optical confinement is weak. Since a radius of curvature of the optical waveguide formed in glass increases, it is necessary to enlarge the size of an optical device such as a three-dimensional optical waveguide device that is obtained, that is, an increase in size of the optical device is necessary.

### Effects of Present Disclosure

According to the present disclosure, it is possible to form an optical waveguide at the inside of glass, and it is possible to reduce a size of an optical device such as a three-dimensional optical waveguide device by enlarging a refractive index variation.

### Description of Embodiments of Present Disclosure

First, contents of an embodiment of the present disclosure will be listed and described. A method for manufacturing an optical device according to an embodiment includes: a laser irradiation step of condensing pulsed first laser light and pulsed second laser light to the inside of a glass member including germanium (Ge) and titanium (Ti) to cause a photo-induced refractive index variation to occur in the glass member; and a condensing position movement step of moving condensing positions of the first laser light and the second laser light relatively to the glass member. Each of the first laser light and the second laser light has a repetition frequency of 10 kHz or greater. In the laser irradiation step, the first laser light is condensed to a dot-shaped condensing region, and the second laser light is condensed to an annular condensing region surrounding the condensing region of the first laser light. A central wavelength of the first laser light is greater than 400 nm and equal to or less than 700 nm, and a central wavelength of the second laser light is equal to or greater than 800 nm and equal to or less than 1100 nm. A continuous refractive index variation region is formed at the inside of the glass member by alternately repeating the laser irradiation step and the condensing position movement step, or by performing the laser irradiation step and the condensing position movement step in parallel.

In the laser irradiation step of the manufacturing method, the pulsed first laser light and the pulsed second laser light are condensed to the inside of the glass member to cause a photo-induced refractive index variation to occur in the glass member. The central wavelength of the first laser light is greater than 400 nm and equal to or less than 700 nm, the first laser light has a repetition frequency of 10 kHz or greater, and the glass member includes Ge of which an absorption edge wavelength is approximately 400 nm. In this case, multi-photon absorption (mainly, two-photon absorption) of the first laser light occurs in the condensing region inside the glass member in which light intensity becomes high. Accordingly, energy of the first laser light in the condensing region becomes equal to or greater than energy of a photon having a wavelength of 400 nm, and a Ge bond is cut. That is, a bond defect of the additive material occurs. As a result, densification glass is induced due to a composition variation, and only a refractive index of the condensing region becomes higher than that of a surrounding region (hereinafter, referred to as a structure-induced refractive index variation). On the other hand, the central wavelength of the second laser light is 800 nm or greater, the second laser light has a repetition frequency of 10 kHz or greater, and the glass member includes Ti. In this case, high-pressure plasma is generated in the condensing region inside the glass member in which the light intensity becomes high. Pressure waves are generated and propagate from the condensing region to an outer side by dynamic compression due to impact of the high-pressure plasma, and a compressive stress occurs toward a central portion of the condensing region due to elastic constraint. Accordingly, densification of glass occurs in the condensing region. A refractive index of glass fluctuates due to the densification of glass (hereinafter, referred to as a pressure-induced refractive index variation). According to the finding obtained by the present inventors, in a case where the glass member includes Ti, the pressure-induced refractive index variation decreases the refractive index of glass.

In addition, in the manufacturing method, the first laser light is condensed to the dot-shaped condensing region, and the second laser light is condensed to the annular condensing region surrounding the condensing region of the first laser light. In the region to which the first laser light is condensed, the refractive index increases due to the structure-induced refractive index variation as described above. On the other hand, in the condensing region of the second laser light which surrounds the condensing region of the first laser light, the refractive index decreases due to the pressure-induced refractive index variation as described above. Accordingly, an optical waveguide including a high refractive index region (that is, a core) and a low refractive index region (that is, a clad) surrounding the high refractive index region can be formed inside the glass, and an optical confinement effect can be enhanced by enlarging a refractive index difference between the high refractive index region and the low refractive index region. Accordingly, in an optical device such as a three-dimensional optical waveguide device, a radius of curvature of an optical waveguide formed in glass can be made small, and thus a size reduction is possible.

The pressure-induced refractive index variation also occurs in the condensing region of the first laser light, and thus there is a concern that the refractive index variation decreases the refractive index of the condensing region of the first laser light. However, the condensing region of the first laser light is surrounded by the annular condensing region of the second laser light, and thus when the first laser light and the second laser light are emitted in synchronization with each other, pressure waves of the first laser light and pressure waves of the second laser light are canceled. Accordingly, the pressure-induced refractive index variation of the condensing region of the first laser light is suppressed, and the structure-induced refractive index variation due to the multi-photon absorption becomes dominant.

In the above-described manufacturing method, the glass member may further include boron (B), and the central wavelength of the first laser light may be 530 nm or less. Absorption of boron starts from the vicinity of 265 nm, and thus when the central wavelength of the first laser light is 530 nm or less, energy in the condensing region of the first laser light due to the multi-photon absorption (mainly, two-photon absorption) becomes equal to or greater than energy of photons in a wavelength of 265 nm, and a bond of boron can be cut. That is, a bond defect of an additive material occurs. As a result, densification of glass due to a composition variation is further effectively induced, and the structure-induced refractive index variation can be further increased. Accordingly, a refractive index difference between the high refractive index region and the low refractive index region can be further increased.

The above-described manufacturing method may further include a step of loading hydrogen into the glass member before the laser irradiation step. According to this, the bond that is cut by the structure-induced refractive index variation is bonded to a hydrogen atom, and thus glass densified due to the composition variation can be stabilized. In this case, in the step of loading hydrogen, the glass member may be put in a hydrogen atmosphere of 10 atm or greater. According to this, hydrogen can be easily loaded into the glass member. The above-described manufacturing method may further include a step of storing the hydrogen-loaded glass member is loaded at a low temperature of −10° C. or lower after the step of loading hydrogen and before the laser irradiation step.

In the above-described manufacturing method, the glass member may be phosphate-based glass or silicate-based glass. In this case, a refractive index in the pressure-induced refractive index variation can be more effectively decreased. Accordingly, the refractive index difference between the high refractive index region and the low refractive index region can be further increased.

In the above-described manufacturing method, a pulse width of the first laser light may be longer than a pulse width of the second laser light. According to this, the refractive index of the high refractive index region can be further increased by reducing the pressure-induced refractive index variation in the condensing region (that is, the high refractive index region) of the first laser light. In this case, the pulse width of the first laser light may be longer than 500 femtoseconds and equal to or shorter than 50 picoseconds, and the pulse width of the second laser light may be equal to or shorter than 500 femtoseconds.

In the condensing position movement step in the manufacturing method, the condensing positions of the first laser light and the second laser light may be moved relatively to the glass member in a direction intersecting a plane including a condensing ring of the second laser light. In this case, irradiation with the second laser light in a manner of superimposing on the high refractive index region formed already (or, irradiation with the first laser light in a manner of superimposing on the low refractive index region formed already) can be suppressed, and thus the refractive index difference between the high refractive index region and the low refractive index region which are formed already can be maintained.

The above-described manufacturing method may further include a step of performing a heat treatment for an aging treatment and removal of residual hydrogen with respect to the glass member after forming the continuous refractive index variation region at the inside of the glass member.

An optical device according to an embodiment includes a glass member that includes germanium and titanium. The glass member includes a photo-induced continuous refractive index variation region at the inside. The refractive index variation region includes a first region that extends in a linear shape, and a second region in a tubular shape surrounding the first region. A refractive index of the first region is greater than a refractive index of a region at the periphery of the refractive index variation region. A refractive index of the second region is smaller than the refractive index of the region at the periphery of the refractive index variation region. According to the optical device, an optical waveguide can be constituted at the inside of the glass member by the first region (that is, the high refractive index region) and the second region (that is, the low refractive index region) surrounding the first region. According to the above-described manufacturing method, the optical device in which the optical waveguide is formed at the inside of glass can be manufactured. In addition, according to the optical device, downsizing can be realized by increasing the refractive index variation.

In the optical device, a shape of the first region may be a circular shape in a cross-section orthogonal to an extension direction of the refractive index variation region, and a shape of the second region may be an annular shape in the cross-section. A center of the second region may match a center of the first region in the cross-section. An inner edge of the second region in the cross-section may match an outer edge of the first region in the cross-section.

A manufacturing apparatus for an optical device according to an embodiment is a manufacturing apparatus for forming a continuous refractive index variation region at the inside of a glass member. The manufacturing apparatus includes a first laser light source, a second laser light source, a conversion element, a wavelength combiner, and a condensing optical system. The first laser light source is configured to emit first laser light in which a central wavelength is greater than 400 nm and equal to or less than 700 nm, and which has a repetition frequency of 10 kHz or greater. The second laser light source is configured to emit second laser light in which a central wavelength is equal to or greater than 800 nm and equal to or less than 1100 nm, and which has a repetition frequency of 10 kHz or greater. The conversion element is disposed on an optical path of the second laser light emitted from the second laser light source, and is configured to convert a beam profile of the second laser light into an annular shape. The wavelength combiner is disposed on the optical path of the first laser light and the second laser light, and is configured to combine the first laser light with the second laser light of which the beam profile is converted by the conversion element. The condensing optical system is configured to condense laser light combined by the wavelength combiner to a predetermined processing position of the glass member.

### Detailed Description of Embodiments of Present Disclosure

Specific examples of the method for manufacturing an optical device, the optical device, and the manufacturing apparatus for the optical device according to an embodiment of the present disclosure will be described in detail with reference to the accompanying drawings. The invention is not limited to the examples and is defined by the appended claims, and the invention is intended to include meanings equivalent to the appended claims and all modifications in the scope of the claims. In the following description, the same reference numeral will be given to the same element, and redundant description thereof will be omitted.

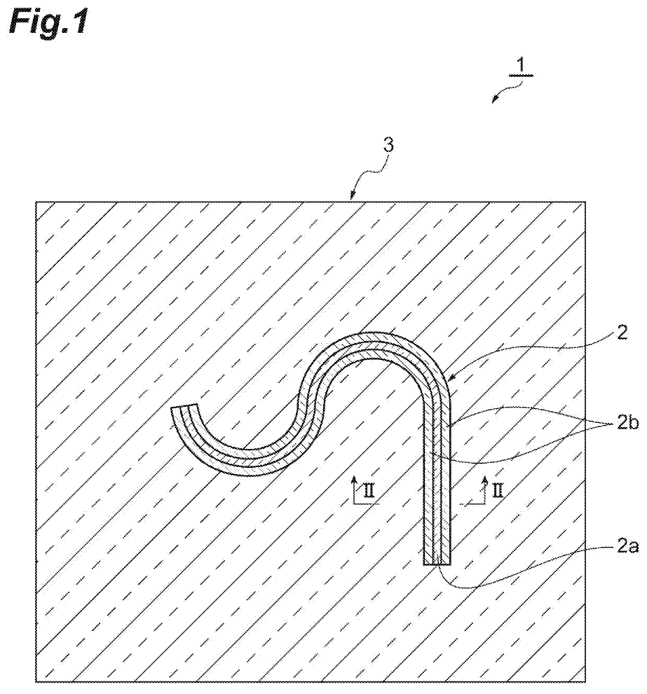

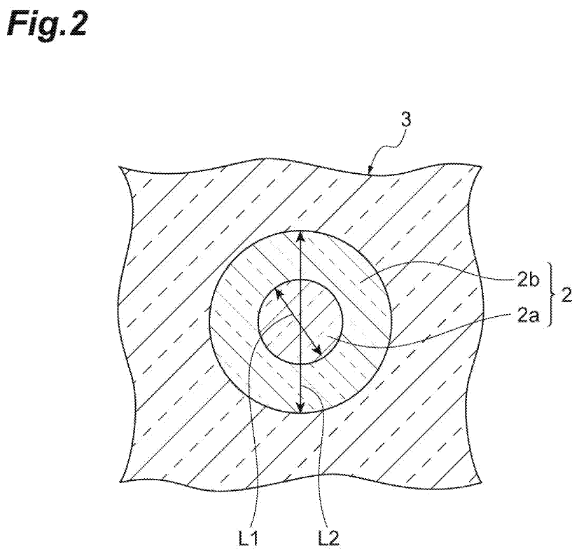

FIG. 1 and FIG. 2 are cross-sectional views illustrating a structure of an optical device 1 that is manufactured by the manufacturing method for an optical device according to this embodiment. FIG. 1 illustrates a cross-section along an extension direction of an optical waveguide 2 provided in the optical device 1, and FIG. 2 illustrates a cross-section orthogonal to the extension direction of the optical waveguide 2 (that is, a cross-section II-II in FIG. 1) in an enlarged manner. As illustrated in FIG. 1 and FIG. 2, the optical device includes a glass member 3. For example, an external shape of the glass member 3 is a rectangular parallelepiped. The glass member 3 mainly includes phosphate-based glass or silicate-based glass, and is formed from phosphate-based glass or silicate-based glass that includes an additive material in an example. The glass member 3 includes germanium (Ge) and Titanium (Ti) as the additive material. Specifically, Ge exists as GeO₂ at the inside of the glass member 3, and Ti exists as TiO₂ at the inside of the glass member 3. The glass member 3 may include boron (B) as the additive material. Specifically, boron exists as B₂O₃ at the inside of the glass member 3. The additive materials are uniformly distributed over the entirety of the glass member 3.

The optical waveguide 2 is formed at the inside of the glass member 3. The optical waveguide 2 is a photo-induced continuous refractive index variation region. As to be described later, the optical waveguide 2 is a region that is formed by condensing pulsed laser light to the inside of the glass member 3 and by continuously moving a condensing position. The optical waveguide 2 extends in an arbitrary direction at the inside of the glass member 3, and has a three-dimensional structure. The optical waveguide 2 includes a high refractive index region 2a that linearly extends and a tubular low refractive index region 2b surrounding the high refractive index region 2a. As illustrated in FIG. 2, a shape of the high refractive index region 2a in a cross-section orthogonal to an extension direction (that is, an optical axis direction of the optical waveguide 2) is, for example, a circular shape, and a shape of the low refractive index region 2b in the same cross-section is, for example, an annular shape. The center of the circular high refractive index region 2a may match the center of the annular low refractive index region 2b. For example, a diameter L1 of the high refractive index region 2a is within a range of 0.5 μm to 15.0 μm, and is 3 μm in an example. A diameter L2 of the low refractive index region 2b is, for example, within a range of 10.0 μm to 20.0 μm, and is 15.0 μm in an example. An outer edge of the high refractive index region 2a may match an inner edge of the low refractive index region 2b, or may be separated from the inner edge. Alternatively, an edge portion of the high refractive index region 2a may slightly overlap an inner edge portion of the low refractive index region 2b.

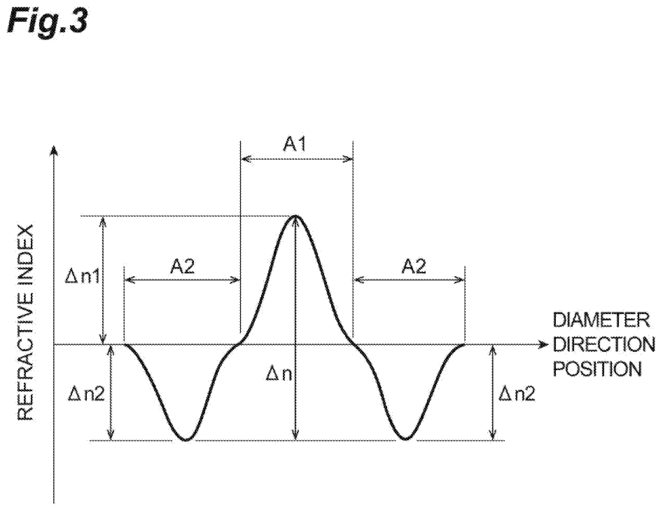

FIG. 3 is a graph showing a refractive index distribution in a diameter direction of the optical waveguide 2. In FIG. 3, a range A1 corresponds to the high refractive index region 2a, and a range A2 corresponds to the low refractive index region 2b. As shown in FIG. 3, in the high refractive index region 2a, a refractive index at an outer edge is the same as a refractive index of a region at the periphery of the optical waveguide 2 (that is, a refractive index of the glass member 3), and the refractive index gradually increases as going toward the center, and the refractive index becomes peak at the center. For example, a shape indicating a refractive index variation in the diameter direction of the high refractive index region 2a is a Gaussian distribution shape, or a step shape. On the other hand, in the low refractive index region 2b, a refractive index at an inner edge and an outer edge is the same as the refractive index of the region at the periphery of the optical waveguide 2 (that is, the refractive index of the glass member 3), and the refractive index gradually decreases as going toward an intermediate line between the inner edge and the outer edge, and becomes minimum at the intermediate line between the inner edge and the outer edge. For example, a shape indicating a refractive index variation between the inner edge and the outer edge in the diameter direction of the low refractive index region 2b is a shape inverted from the Gaussian distribution, or a shape inverted from a step index shape.

A refractive index difference Δn1 between the maximum refractive index in the high refractive index region 2a and the refractive index of the region at the periphery of the optical waveguide 2 (that is, the refractive index of the glass member 3) is, for example, within a range of 0.001 to 0.040. On the other hand, a refractive index difference Δn2 between the minimum refractive index in the low refractive index region 2b and the refractive index of the region at the periphery of the optical waveguide 2 is, for example, within a range of 0.001 to 0.040. Accordingly, a refractive index difference Δn (=Δn1+Δn2) between the maximum refractive index in the high refractive index region 2a and the minimum refractive index in the low refractive index region 2b is, for example, within a range of 0.002 to 0.080.

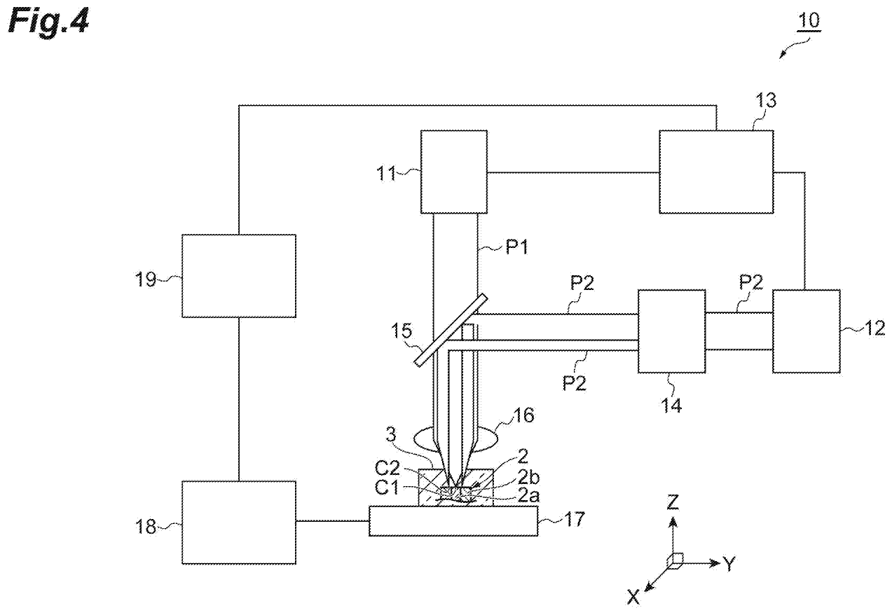

FIG. 4 is a view schematically illustrating a configuration of a manufacturing apparatus 10 for manufacturing the optical device 1. As illustrated in FIG. 4, the manufacturing apparatus 10 includes a first laser light source 11, a second laser light source 12, a laser drive unit 13 configured to drive the laser light sources 11 and 12, a laser shape conversion element 14, a wavelength combiner 15, a condensing optical system (for example, a condensing lens) 16, an XYZ stage 17, a stage drive unit 18 configured to drive the XYZ stage 17, and a control unit 19 configured to control an operation of the laser drive unit 13 and the stage drive unit 18.

The laser light source 11 outputs pulsed first laser light P1 for forming the high refractive index region 2a. The power peak value (that is, peak power) of the first laser light P1 has the amount of energy that causes a photo-induced refractive index variation to occur in the glass member 3, and has a repetition frequency of 10 kHz or greater. Here, the photo-induced refractive index variation represents a refractive index variation that is induced at the inside of the glass member 3 due to light irradiation with laser light or the like. The refractive index variation is defined by a maximum refractive index difference in a light irradiation region in which a refractive index variation occurs with a refractive index of a region other than the light irradiation region set as a reference. The amount of energy that causes the photo-induced refractive index variation to occur in the glass member 3 represents, for example, peak power of 10⁵ W or grater in the case of this embodiment. Since the repetition frequency is 10 kHz or greater, the refractive index and a structure of the high refractive index region 2a formed at the inside of a glass material can be made to be smooth. For example, a pulse width of the first laser light P1 is longer than 500 femtoseconds and equal to or shorter than 50 picoseconds. In this embodiment, the pulse width is defined as a time interval at a point at which amplitude becomes 50% of the maximum amplitude. A central wavelength of the first laser light P1 is greater than 400 nm and equal to or less than 700 nm. In a case where the glass member 3 includes boron, the central wavelength of the first laser light P1 may be 530 nm or less. A beam profile of the first laser light P1 output from the laser light source 11 is, for example, a single peak shape such as a Gaussian distribution shape. The laser light source 11 can be realized by, for example, a laser device of a type such as a second harmonic generation (SHG) laser such as a titanium sapphire laser and a Yb-doped fiber laser.

The laser light source 12 outputs pulsed second laser light P2 for forming the low refractive index region 2b. As in the first laser light P1, peak power of the second laser light P2 has the amount of energy that causes a photo-induced refractive index variation to occur in the glass member 3, and has a repetition frequency of 10 kHz or greater. Even in the second laser light P2, the amount of energy that causes the photo-induced refractive index variation to occur in the glass member 3 represents, for example, peak power of 10⁵ W or greater. Since the repetition frequency is 10 kHz or greater, the refractive index and a structure of the low refractive index region 2b formed at the inside of the glass material can be made to be smooth. A pulse width of the second laser light P2 is shorter than the pulse width of the first laser light P1, and is, for example, 500 femtoseconds or shorter. A central wavelength of the second laser light P2 is equal to or greater than 800 nm and equal to or less than 1100 nm, and is 800 nm or 1063 nm in this embodiment. A beam profile of the second laser light P2 output from the laser light source 12 is, for example, a single peak shape such as a Gaussian distribution shape. The laser light source 12 can be realized by, for example, a laser device of a type such as a titanium sapphire laser.

The laser drive unit 13 is electrically connected to the control unit 19, the laser light source 11, and the laser light source 12. The laser drive unit 13 controls the power, the pulse width, and the repetition frequency of the first laser light P1 output from the laser light source 11, and the power, the pulse width, and the repetition frequency of the second laser light P2 output from the laser light source 12 in accordance with an instruction given from the control unit 19. For example, the laser drive unit 13 can be constituted by an electronic circuit including a large scale integrated circuit. For example, the control unit 19 can be constituted by a computer including a CPU and a memory.

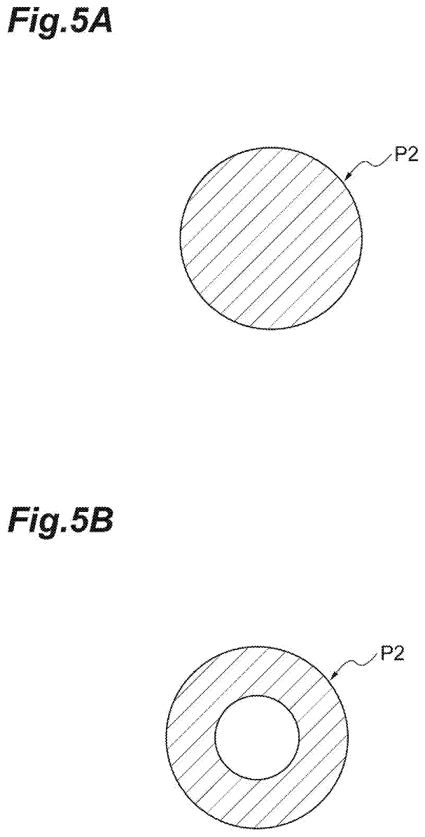

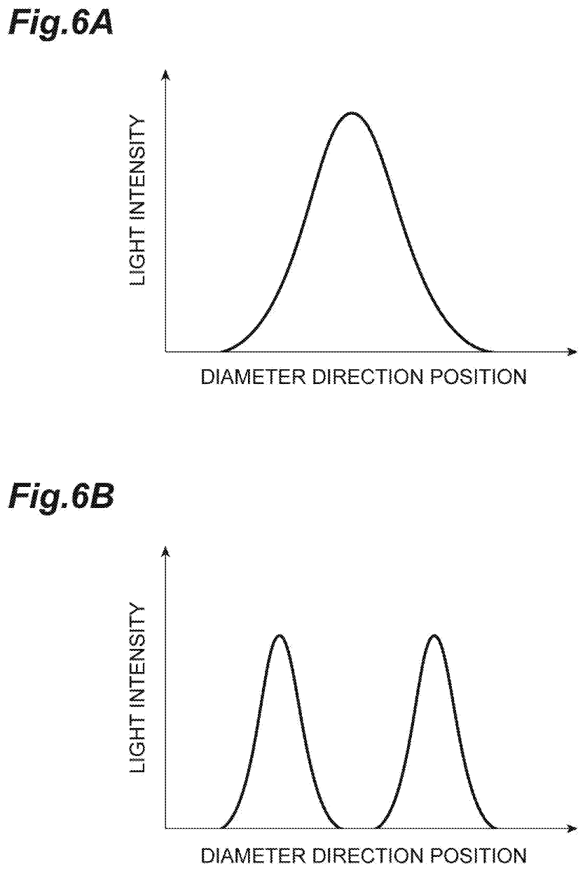

The laser shape conversion element 14 is optically coupled to the laser light source 12, and is disposed on an optical path of the second laser light P2 output from the laser light source 12. The laser shape conversion element 14 changes a light intensity distribution (that is, a beam profile) of the second laser light P2 output from the laser light source 12. Specifically, the beam profile of the second laser light P2 is converted from the single peak shape into an annular shape. FIG. 5A is a view illustrating a cross-sectional shape of the second laser light P2 that is input to the laser shape conversion element 14. FIG. 5B is a view illustrating a cross-sectional shape of the second laser light P2 that is output from the laser shape conversion element 14. FIG. 6A is a graph showing an example of the beam profile of the second laser light P2 that is input to the laser shape conversion element 14. FIG. 6B is a graph showing an example of the beam profile of the second laser light P2 that is output from the laser shape conversion element 14. As the laser shape conversion element 14, for example, a vortex element (that is, a spiral beam shaping element), an M-shaped beam shaping element, or the like is used. An axicon lens is not suitable as the laser shape conversion element 14 because a condensing region of output light is not an annular shape in the axicon lens.

The wavelength combiner 15 is optically coupled to the laser light sources 11 and 12, and is provided at a position at which an optical path of the first laser light P1 output from the laser light source 11 and an optical path of the second laser light P2 output from the laser light source 12 intersect each other. The wavelength combiner 15 allows light in a certain wavelength band to be transmitted therethrough, and reflects light in another wavelength band. In an example illustrated in FIG. 4, the wavelength combiner 15 allows light in a band including a wavelength of the first laser light P1 to be transmitted therethrough, and reflects light in a band including a wavelength of the second laser light P2. The wavelength combiner 15 may reflect light in a band including the wavelength of the first laser light P1 and may allow light in a band including the wavelength of the second laser light P2 to be transmitted therethrough. The wavelength combiner 15 make a central axial line of the first laser light P1 that is transmitted or reflected, and a central axial line of the second laser light P2 that is reflected or transmitted match each other.

The condensing optical system 16 is optically coupled to the wavelength combiner 15, and is disposed on the optical path of the laser light P1 and the laser light P2 output from the wavelength combiner 15. The condensing optical system 16 condenses the first laser light P1 to a dot-shaped condensing region C1 inside the glass member 3, and condenses the second laser light P2 to an annular condensing region C2 surrounding the condensing region C1 inside the glass member 3. In FIG. 4, the glass member 3, and a part of the optical waveguide 2 formed inside the glass member 3 are illustrated as a cross-section corresponding to the cross-section in FIG. 1. In each of the condensing regions C1 and C2, the photo-induced refractive index variation occurs. As a result, the high refractive index region 2a of the optical waveguide 2 is formed in correspondence with the condensing region C1, and the low refractive index region 2b of the optical waveguide 2 is formed in correspondence with the condensing region C2. As the condensing optical system 16, for example, an achromatic lens capable of suppressing the chromatic aberration of the laser light P1 and the laser light P2 of which wavelengths are different from each other is used. The focal length of the condensing optical system 16 may be 100 mm or less in order to increase photon density in the condensing regions C1 and C2 inside the glass member 3.

In the XYZ stage 17, the glass member 3 is mounted on a device mounting surface. The device mounting surface is configured to be movable in an X-direction and a Y-direction which intersect (for example, are orthogonal to) an optical axis of the condensing optical system 16, and intersecting each other (for example, are orthogonal to each other), and a Z-direction along the optical axis of the condensing optical system 16. The device mounting surface can move the glass member 3 relatively to the condensing optical system 16. The condensing optical system 16 may be movable in a state in which a position of the glass member 3 is fixed, or both the glass member 3 and the condensing optical system 16 may be movable. The stage drive unit 18 is electrically connected to the control unit 19 and the XYZ stage 17. The stage drive unit 18 controls a position of the XYZ stage 17 in accordance with an instruction given from the control unit 19.

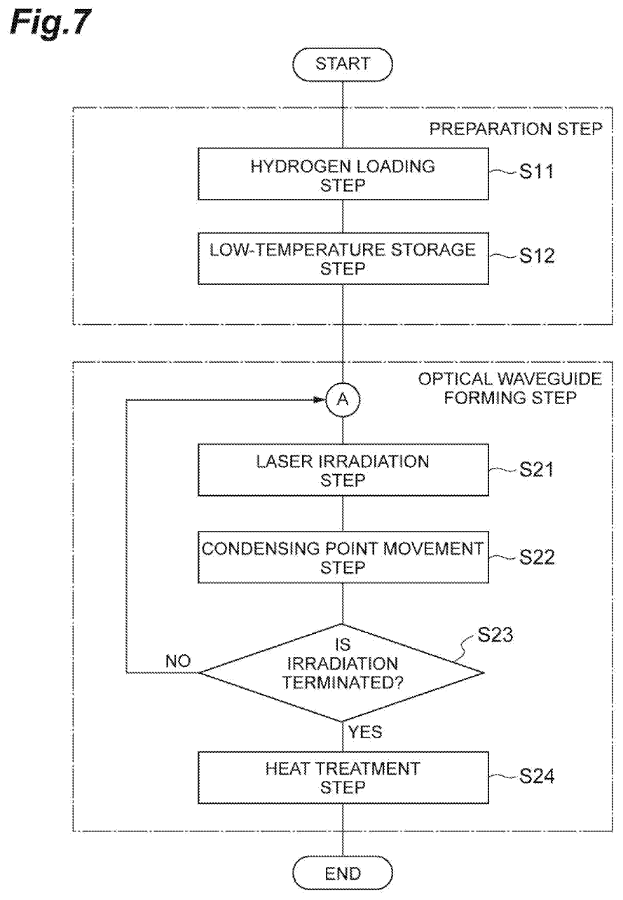

Next, a method for manufacturing the optical device 1 of this embodiment will be described. FIG. 7 is a flowchart illustrating the method for manufacturing the optical device 1 according to this embodiment. As illustrated in FIG. 7, the method for manufacturing the optical device 1 according to this embodiment includes a preparation step and an optical waveguide forming step. First, in the preparation step, the glass member 3 is disposed inside a chamber. The glass member 3 mainly includes phosphate-based glass and silicate-based glass, and includes Ge and Ti as an additive material. The glass member 3 may further include boron as an additive material. In a state in which the glass member 3 is accommodated, a 100% hydrogen gas is put in the chamber, and the atmospheric pressure in the chamber is maintained to 10 atm or higher. For example, a hydrogen loading period is one day to 12 weeks. According to this, hydrogen is loaded into the glass member 3 (step S11, a hydrogen loading step). In a case where the optical waveguide forming step is not performed immediately after the hydrogen loading step in step S11, the hydrogen-loaded glass member 3 is stored at a low temperature of −10° C. or lower so as to suppress the amount of hydrogen leaked from the glass member 3 (step S12).

In the optical waveguide forming step, the optical waveguide 2 having an arbitrary pattern is formed inside the hydrogen-loaded glass member 3. Specifically, the hydrogen-loaded glass member 3 is provided on the device mounting surface of the XYZ stage 17 after completion of step S11, and is irradiated with the pulsed laser light P1 and the pulsed laser light P2 (step S21, a laser irradiation step). The control unit 19 controls the laser drive unit 13 so that the laser light P1 and the laser light P2, which have the amount of energy that causes the photo-induced refractive index variation to occur at the inside of the glass member 3 and have a repetition frequency of 10 kHz or greater, are output from the laser light sources 11 and 12, respectively. The second laser light P2 output from the laser light source 12 is combined with the first laser light P1 output from the laser light source 11 in the wavelength combiner 15 after the beam profile is converted by the laser shape conversion element 14. In addition, the laser light P1 and the laser light P2 which are combined are simultaneously condensed to the inside of the glass member 3 by the condensing optical system 16.

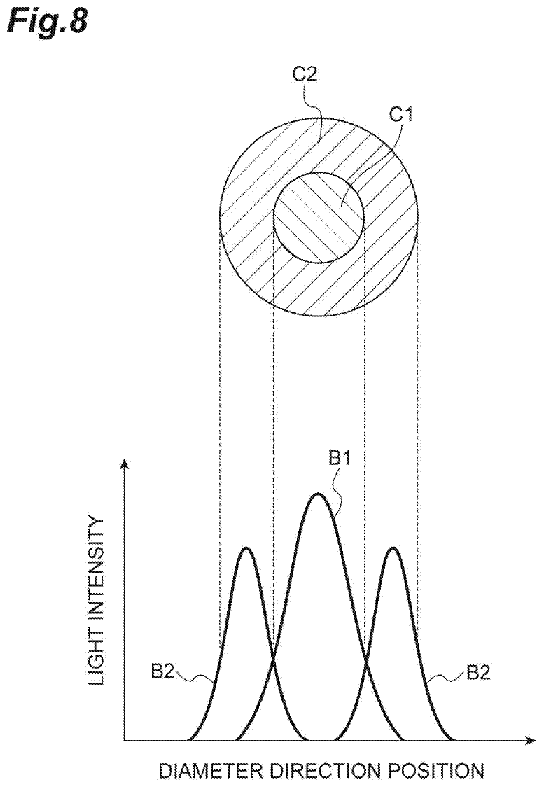

FIG. 8 is a view illustrating the condensing region C1 of the first laser light P1 and the condensing region C2 of the second laser light P2 in a cross-section of the glass member 3 that is orthogonal to the optical axis of the condensing optical system 16. In FIG. 8, a beam profile of the laser light P1 and a beam profile of the laser light P2 in the cross-section are illustrated in combination. B1 in FIG. 8 represents the beam profile of the first laser light P1, and B2 in FIG. 8 represents the beam profile of the second laser light P2. As illustrated in FIG. 8, in step S21, the first laser light P1 is condensed to a dot-shaped condensing region, and the second laser light P2 is condensed to an annular condensing region surrounding the condensing region of the first laser light P1. According to this, the photo-induced refractive index variation occurs in each of the condensing regions C1 and C2, and the high refractive index region 2a and the low refractive index region 2b illustrated in FIG. 2 and FIG. 4 are formed. The depths of the condensing regions C1 and C2 from a light incident surface of the glass member 3 are equal to each other.

When laser irradiation of a predetermined portion in the glass member 3 is completed, the control unit 19 controls the stage drive unit 18, and moves the position of the glass member 3 provided on the device mounting surface of the XYZ stage 17 (step S22, a condensing position movement step). At this time, condensing positions of the laser light P1 and the laser light P2 are moved relatively to the glass member 3 in a direction intersecting an XY plane (that is, the cross-section illustrated in FIG. 8) including the condensing region C2 of the second laser light P2. The movement is not limited to movement in a direction orthogonal to a plane including the condensing region C2 (that is, an optical axis direction of the condensing optical system 16), and may include movement in a direction inclined with respect to a plane including the condensing region C2. In a case where an extension direction of the optical waveguide 2 is bent by 90° or greater, irradiation with the laser light P1 and the laser light P2 may be performed while inclining the glass member 3 by a desired angle by using the XYZ stage 17 in which an angle of the device mounting surface can be adjusted. In this manner, in step S22, the condensing region C1 of the first laser light P1 and the condensing region C2 of the second laser light P2 at the inside of the glass member 3 are moved by continuously or intermittently changing the position of the glass member 3, and/or the condensing positions of the laser light P1 and the laser light P2.

With regard to the laser irradiation step in step S21 and the condensing position movement step in step S22, that is, operation control on the laser drive unit 13 and the stage drive unit 18 by the control unit 19, until an optical waveguide pattern designed in advance is formed at the inside of the glass member 3, it returns to a point of time indicated by point A in FIG. 7, and the operation control is repetitively performed while changing irradiation conditions or under the same irradiation conditions (step S23: NO). That is, until the optical waveguide 2 illustrated in FIG. 1 is formed at the inside of the glass member 3, step S21 and step S22 are alternately repeated. Alternatively, until the optical waveguide 2 is formed at the inside the glass member 3, step S21 and step S22 may be performed in parallel. Formation of the optical waveguide 2 in the glass member 3 is completed (step S23: YES), a heat treatment for an aging treatment and removing residual hydrogen is performed with respect to the glass member 3 so as to suppress a variation of the refractive index difference Δn for a long period (step S24). The optical device 1 illustrated in FIG. 1 is obtained through the above-described steps (that is, steps S11, S21, S22, S23, and S24, or steps S11, S12, S21, S22, S23, and S24).

Here, the laser irradiation step of forming the optical waveguide 2 by the photo-induced refractive index variation (step S21) will be described in detail. A mechanism of causing a refractive index to vary at the inside of a glass member by condensing laser light to the glass member is classified into two types as described below.

A first mechanism is a mechanism in which a bond of an additive material such as Ge included in the glass member is cut with laser light in order for a bond defect to occur, and the refractive index varies due to the bond defect. When the bond defect occurs, densification of glass due to a composition variation is induced, and only a refractive index of a laser irradiation region becomes higher than that of a surrounding region. That is, this corresponds to the structure-induced refractive index variation. The above-described high refractive index region 2a is formed by the structure-induced refractive index variation.

In the first mechanism, laser light having a wavelength shorter than an absorption edge wavelength of an additive material may be used to cut the bond of the additive material. However, in this case, even in a region of a glass material existing between a light incident surface and a condensing region of the glass member, the additive material absorbs the laser light going toward the condensing region (that is, before condensing), and the bond of the additive material is cut. Accordingly, it is difficult to cause the refractive index variation to occur only in the condensing region. Here, in this embodiment, the bond of the additive material is cut only in the condensing region by multi-photon absorption (mainly, two-photon absorption) to cause the refractive index variation to occur. For example, in the case of the two-photon absorption, energy corresponding to the half of a wavelength of the laser light is applied to the glass material in a region in which the two-photon absorption occurs. Accordingly, when the half of the wavelength of the laser light is set to be shorter than the absorption edge wavelength of the additive material, and the wavelength of the laser light is set to be longer than the absorption edge wavelength of the additive material, it is possible to cut the bond of the additive material only in the region in which the two-photon absorption occurs. Adjustment of laser light irradiation conditions for causing the two-photon absorption to occur only in the condensing region in which light intensity becomes high, and for preventing the two-photon absorption from occurring in the region of the glass material existing between the light incident surface and the condensing region of the glass member is very easy.

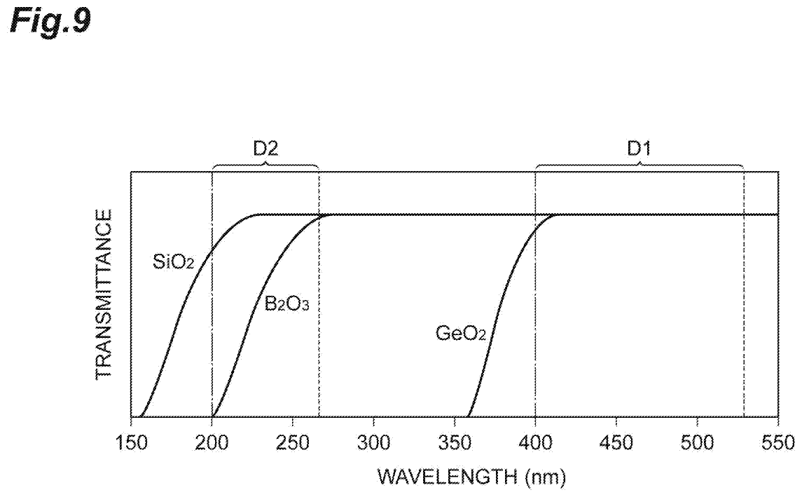

FIG. 9 is a graph showing results of measurement on a transmittance variation for an incident light wavelength with respect to each material (for example, SiO₂, GeO₂, or B₂O₃) that constitutes the glass member. As shown in FIG. 9, a transmittance of SiO₂ gradually increases from 150 nm to 220 nm, a transmittance of B₂O₃ gradually increases from 200 nm to 265 nm, and a transmittance of GeO₂ gradually increases from 350 nm to 400 nm. The glass member 3 of this embodiment includes Ge as an additive material. In order to sufficiently cut a bond of Ge, energy corresponding to a wavelength of 350 nm or less may be generated by the two-photon absorption. Accordingly, the upper limit of a central wavelength of the first laser light P1 becomes 700 nm. In addition, when the central wavelength of the first laser light P1 is set to be greater than 400 nm, the refractive index variation in a region of the glass material existing between the light incident surface and the condensing region C1 of the glass member 3 can be suppressed. Accordingly, a central wavelength range of the first laser light P1 becomes greater than 400 nm and equal to or less than 700 nm. In a case where the glass member 3 includes boron, in order to cut a bond of boron, energy corresponding to a wavelength of 265 nm or less may be generated by the two-photon absorption. Accordingly, the upper limit of the central wavelength of the first laser light P1 may be set to 530 nm. That is, the central wavelength range of the first laser light P1 becomes greater than 400 nm and equal to or less than 530 nm (refer to a wavelength range D1 in FIG. 9). In this case, a range of energy that is generated by the two-photon absorption corresponds to a wavelength range D2 that is greater than 200 nm and equal to or less than 265 nm.

The first mechanism (that is, the structure-induced refractive index variation) is also used, for example, when forming a grating structure in a core of an optical fiber.

A second mechanism is a mechanism in which high-pressure plasma is generated in a condensing region inside the glass member in which light intensity becomes high, pressure waves are generated and propagate from the condensing region to an outer side by dynamic compression due to impact of the high-pressure plasma, a compressive stress occurs toward a central portion of the condensing region due to elastic constraint, and thus densification of glass occurs in the condensing region. The refractive index of glass varies by a residual stress (for example, a compressive stress and/or a tensile stress) inside the glass due to the densification of the glass. That is, this corresponds to a pressure-induced refractive index variation. The low refractive index region 2b is formed by the pressure-induced refractive index variation. In this embodiment, the glass member 3 includes Ti. According to the finding obtained by the present inventors, in a case where the glass member includes Ti, the pressure-induced refractive index variation decreases the refractive index of glass. Non Patent Literature 1 discloses that when phosphate-based glass including Ge, Ti, and B is irradiated with laser light, the refractive index variation Δn2 becomes negative, and an absolute value thereof exceeds 0.015. It is preferable that the central wavelength of the second laser light P2 is 800 nm or greater so that in the low refractive index region 2b, the second mechanism is caused to occur, and the first mechanism is prevented from occurring, that is, so that in the two-photo absorption that is the first mechanism, an absorption edge of GeO₂ is not reached and three-photon or more absorption of which occurrence probability is lower in comparison to the two-photo absorption is established.

An effect obtained by the optical device 1 and the manufacturing method for the optical device 1 according to the above-described embodiment will be described. In this embodiment, as illustrated in FIG. 8, the first laser light P1 is condensed to the dot-shaped condensing region C1, and the second laser light P2 is condensed to the annular condensing region C2 surrounding the condensing region C1 of the first laser light P1. In the condensing region C1 to which the first laser light P1 is condensed, a refractive index increases due to the structure-induced refractive index variation. On the other hand, in the condensing region C2 of the second laser light P2 which surrounds the condensing region C1 of the first laser light P1, the refractive index decreases due to the pressure-induced refractive index variation. Accordingly, the optical waveguide 2 including the high refractive index region 2a (that is, a core), and the low refractive index region 2b (that is, a clad) surrounding the high refractive index region 2a can be formed at the inside of the glass member 3, and an optical confinement effect can be enhanced by enlarging a refractive index difference Δn between the high refractive index region 2a and the low refractive index region 2b. Accordingly, in the optical device 1 such as a three-dimensional optical waveguide device, a radius of curvature of the optical waveguide 2 formed in the glass member 3 can be made small, and thus a size reduction is possible.

The pressure-induced refractive index variation also occurs in the condensing region C1 of the first laser light P1, and thus there is a concern that the refractive index variation decreases the refractive index of the condensing region C1 of the first laser light P1. However, when the first laser light P1 and the second laser light P2 are emitted in synchronization with each other, pressure waves of the first laser light P1 and pressure waves of the second laser light P2 are canceled. Accordingly, the pressure-induced refractive index variation of the first laser light irradiation region is suppressed, and the structure-induced refractive index variation due to the multi-photon absorption becomes dominant. As a result, the refractive index difference Δn between the high refractive index region 2a and the low refractive index region 2b can be increased.

As in this embodiment, the glass member 3 may further include boron, and the central wavelength of the first laser light P1 may be 530 nm or less. As described above, absorption of boron starts from the vicinity of 265 nm, and thus when the central wavelength of the first laser light P1 is 530 nm or less, energy in the condensing region C1 of the first laser light P1 due to the multi-photon absorption (mainly, two-photon absorption) becomes equivalent to 265 nm or less, and a bond of boron can be cut. As a result, densification of glass due to a composition variation is further effectively induced, and the structure-induced refractive index variation can be further increased. Accordingly, a refractive index difference Δn between the high refractive index region 2a and the low refractive index region 2b can be further increased.

As in this embodiment, the hydrogen loading step of loading hydrogen into the glass member 3 may be further performed before the laser irradiation step. According to this, the bond that is cut by the structure-induced refractive index variation is bonded to a hydrogen atom, and thus re-bonding of the cut bond is suppressed, high densification of glass due to the composition variation can be stabilized. In this case, in the step of loading hydrogen, the glass member 3 may be put in a hydrogen atmosphere of 10 atm or greater. According to this, hydrogen can be easily loaded into the glass member 3.

As in this embodiment, the glass member 3 may mainly include phosphate-based glass or silicate-based glass. In this case, a refractive index in the pressure-induced refractive index variation can be more effectively decreased. Accordingly, the refractive index difference Δn between the high refractive index region 2a and the low refractive index region 2b can be further increased.

As in this embodiment, the pulse width of the first laser light P1 may be longer than the pulse width of the second laser light P2. According to this, a peak value of the power of the first laser light P1 is suppressed, and thus the multi-photon absorption can be dominant by reducing the pressure-induced refractive index variation in the condensing region C1 (that is, the high refractive index region 2a). As a result, the refractive index of the high refractive index region 2a can be further increased. In order to reduce the pressure-induced refractive index variation in the condensing region C1, the pulse width of the first laser light P1 may be longer than 500 femtoseconds. On the other hand, it is necessary to raise a power peak value of the second laser light P2 to promote the pressure-induced refractive index variation in the condensing region C2, the pulse width may be 500 femtoseconds or shorter.

As in this embodiment, in the condensing position movement step, the condensing positions of the laser light P1 and the laser light P2 may be moved relatively to the glass member 3 in the direction intersecting the XY plane including the condensing region C2 of the second laser light P2. In this case, irradiation with the second laser light P2 in a manner of superimposing on the high refractive index region 2a formed already (or, irradiation with the first laser light P1 in a manner of superimposing on the low refractive index region 2b formed already) can be suppressed, and thus the refractive index difference Δn between the high refractive index region 2a and the low refractive index region 2b which are formed already can be maintained.

According to the optical device 1 of this embodiment, the optical waveguide 2 can be constituted at the inside of the glass member 3 by the high refractive index region 2a and the low refractive index region 2b surrounding the high refractive index region 2a. According to the above-described manufacturing method, the optical device 1 in which the optical waveguide 2 is formed at the inside of the glass member 3 can be manufactured. In addition, according to the optical device 1, downsizing can be realized by increasing the refractive index difference Δn between the high refractive index region 2a and the low refractive index region 2b.

The method for manufacturing the optical device, the optical device, and the manufacturing apparatus for the optical device according to the invention are not limited to the above-described embodiment, and various other modification can be made. For example, in the above-described embodiment, the hydrogen loading step is performed before the laser irradiation step, but the hydrogen loading step may be omitted. In the above-described embodiment, the glass member mainly including the phosphate-based glass or the silicate-based glass is used, but the invention is applicable to a glass member that does not include or slightly includes the glass (for example, quartz-based glass, halide glass, sulfide glass, or the like).

### REFERENCE SIGNS LIST

1: optical device, 2: optical waveguide, 2a: high refractive index region, 2b: low refractive index region, 3: glass member, 10: manufacturing apparatus, 11: first laser light source, 12: second laser light source, 13: laser drive unit, 14: laser shape conversion element, 15: wavelength combiner, 16: condensing optical system, 17: XYZ stage, 18: stage drive unit, 19: control unit, C1, C2: condensing region, P1: first laser light, P2: second laser light, Δn: refractive index difference.

What is claimed is:

1. A method for manufacturing an optical device, comprising:
a laser irradiation step of condensing pulsed first laser light and pulsed second laser light in a glass member including germanium and titanium to cause a photo-induced refractive index variation in the glass member; and
a condensing position movement step of moving condensing positions of the first laser light and the second laser light relatively to the glass member,
wherein each of the first laser light and the second laser light has a repetition frequency of 10 kHz or greater,
the laser irradiation step includes condensing the first laser light to a dot-shaped condensing region and condensing the second laser light to an annular condensing region surrounding the condensing region of the first laser light,
the first laser light has a central wavelength greater than 400 nm and equal to or less than 700 nm, and the second laser light has a central wavelength equal to or greater than 800 nm and equal to or less than 1100 nm, and
the laser irradiation step and the condensing position movement step are alternately repeated or are performed in parallel to form a continuous refractive index variation region in the glass member.

2. The method for manufacturing an optical device according to claim 1,
wherein the glass member further includes boron, and the central wavelength of the first laser light emitted in the laser irradiation step is 530 nm or less.

3. The method for manufacturing an optical device according to claim 1, further comprising:
loading hydrogen into the glass member before the laser irradiation step.

4. The method for manufacturing an optical device according to claim 3,
wherein the loading hydrogen includes putting the glass member in a hydrogen atmosphere of 10 atm or greater.

5. The method for manufacturing an optical device according to claim 3, further comprising:
storing the hydrogen-loaded glass member at a low temperature of −10° C. or lower after the loading hydrogen and before the laser irradiation step.

6. The method for manufacturing an optical device according to claim 1,
wherein the glass member is phosphate-based glass or silicate-based glass.

7. The method for manufacturing an optical device according to claim 1,
wherein the first laser light has a pulse width longer than a pulse width of the second laser light.

8. The method for manufacturing an optical device according to claim 7,
wherein the pulse width of the first laser light is longer than 500 femtoseconds and equal to or shorter than 50 picoseconds, and the pulse width of the second laser light is equal to or shorter than 500 femto seconds.

9. The method for manufacturing an optical device according to claim 1,
wherein the condensing position movement step includes moving the condensing positions of the first laser light and the second laser light relatively to the glass member in a direction intersecting a plane including the annular condensing region of the second laser light.

10. The method for manufacturing an optical device according to claim 1, further comprising:
performing a heat treatment for an aging treatment and removal of residual hydrogen with respect to the glass member after forming the continuous refractive index variation region at the inside of the glass member.

11. An optical device, comprising:
a glass member having an inside including germanium and titanium, the glass member including a photo-induced continuous refractive index variation region,
wherein the refractive index variation region includes a first region extending in a linear shape, and a second region in a tubular shape surrounding the first region,
a refractive index of the first region is greater than a refractive index of a region at the periphery of the refractive index variation region, and
a refractive index of the second region is smaller than the refractive index of the region at the periphery of the refractive index variation region.

12. The optical device according to claim 11,
wherein the first region has a circular shape in a cross-section orthogonal to an extension direction of the continuous refractive index variation region, and the second region has an annular shape in the cross-section.

13. The optical device according to claim 11,
wherein a center of the second region matches a center of the first region in a cross-section orthogonal to an extension direction of the continuous refractive index variation region.

14. The optical device according to claim 11,
wherein an inner edge of the second region in a cross-section orthogonal to an extension direction of the continuous refractive index variation region matches an outer edge of the first region in the cross-section.

15. A manufacturing apparatus for an optical device for forming a continuous refractive index variation region in a glass member, comprising:
a first laser light source configured to emit first laser light, the first laser light having a central wavelength greater than 400 nm and equal to or less than 700 nm and a repetition frequency of 10 kHz or greater;
a second laser light source configured to emit second laser light, the second laser light having a central wavelength equal to or greater than 800 nm and equal to or less than 1100 nm and a repetition frequency of 10 kHz or greater;
a conversion element disposed on an optical path of the second laser light emitted from the second laser light source, and configured to convert a beam profile of the second laser light into an annular shape;
a wavelength combiner disposed on the optical path of the first laser light and the second laser light, and configured to combine the first laser light and the second laser light, the beam profile of the second laser light having been converted by the conversion element; and
a condensing optical system configured to condense laser light combined by the wavelength combiner to a predetermined processing position of the glass member.
